(19) United States
(12) Patent Application Publication
(10) Pub. No.: US 2025/0097353 A1
(43) Pub. Date: Mar. 20, 2025

(54) IMAGE INSPECTION APPARATUS, NON-TRANSITORY COMPUTER-READABLE RECORDING MEDIUM, AND IMAGE INSPECTION METHOD

(71) Applicant: Konica Minolta, Inc., Tokyo (JP)

(72) Inventor: Kazuomi SAKATANI, Tokyo (JP)

(21) Appl. No.: 18/886,408

(22) Filed: Sep. 16, 2024

(30) Foreign Application Priority Data
Sep. 20, 2023 (JP) 2023-151953

(51) Int. Cl. H04N 1/00; G06T 3/40; G06T 7/00

(52) U.S. Cl. CPC H04N 1/00029; G06T 3/40; G06T 7/0002; H04N 1/00013

(57) ABSTRACT

Provided is an image forming apparatus including: a hardware processor that adds a reference pattern for alignment to image data; an image former; and a reader. The hardware processor generates the reference pattern in a shape identifiable by the hardware processor regardless of a resolution of an inspection image, and executes comparison inspection between the inspection image based on a read image and a reference image.

### CROSS REFERENCE TO RELATED APPLICATIONS

The entire disclosure of Japanese patent Application No. 2023-151953, filed on Sep. 20, 2023, is incorporated herein by reference in its entirety.

### BACKGROUND

### 1. Technological Field

The present invention relates to an image inspection apparatus, a non-transitory computer-readable recording medium, and an image inspection method.

### 2. Description of the Related Art

In the related art, there is known a technology in which image inspection is performed by executing comparison inspection between an inspection image, which is based on a read image obtained by reading an image based on image data to which a reference pattern for alignment during image inspection has been added, and a reference image (see, for example, Japanese Patent Application Laid-Open No. 2022-14759).

### SUMMARY

However, a reference pattern may disappear or blur depending on the resolution of an inspection image. For this reason, there arises a problem that the accuracy of alignment between an inspection image and a reference image during image inspection decreases.

An object of the present invention is to provide an image inspection apparatus, a non-transitory computer-readable recording medium, and an image inspection method each capable of improving the accuracy of alignment between an inspection image and a reference image during image inspection.

In order to achieve at least one of the above-described objects, an image inspection apparatus reflecting one aspect of the present invention includes: a hardware processor that adds a reference pattern for alignment to image data; an image former that forms, on a recording medium, an image based on the image data to which the reference pattern has been added; and a reader that reads the image formed on the recording medium to generate a read image, and the hardware processor generates, during image inspection, the reference pattern in a shape identifiable by the hardware processor regardless of a resolution of an inspection image, and executes comparison inspection between the inspection image based on the read image and a reference image.

In order to realize at least one of the above-described objects, a non-transitory computer-readable recording medium reflecting one aspect of the present invention is a non-transitory computer-readable recording medium storing an image inspection program to be executed by an image inspection apparatus. The image inspection program causes a computer to execute: adding a reference pattern for alignment to image data; forming, on a recording medium, an image based on the image data to which the reference pattern has been added; reading the image formed on the recording medium to generate a read image; and inspecting in which comparison inspection between an inspection image based on the read image and a reference image is executed, and the adding includes generating the reference pattern in a shape identifiable by the image inspection apparatus regardless of a resolution of the inspection image during image inspection.

In order to realize at least one of the above-described objects, an image inspection method reflecting one aspect of the present invention is an image inspection method which is used by an image inspection apparatus, and includes: adding a reference pattern for alignment to image data; forming, on a recording medium, an image based on the image data to which the reference pattern has been added; generating a read image by reading the image formed on the recording medium; and executing comparison inspection between an inspection image based on the read image and a reference image, and the adding includes generating the reference pattern in a shape identifiable by the image inspection apparatus regardless of a resolution of the inspection image during image inspection.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating an overall configuration of an image inspection system according to an embodiment of the present invention;

FIG. 2 is a block diagram illustrating a main functional configuration of an image forming apparatus;

FIG. 3 is a diagram illustrating a recording medium on which exemplary trim marks are formed;

FIG. 4 is an enlarged view of a corner mark portion in FIG. 3;

FIG. 5 is an enlarged view of a center mark portion in FIG. 3;

FIG. 6 is a diagram illustrating a recording medium on which an exemplary reference pattern is formed;

FIG. 7 is an enlarged view of a portion corresponding to a corner mark in the reference pattern of FIG. 6;

FIG. 8 is an enlarged view of a portion corresponding to a center mark in the reference pattern of FIG. 6;

FIG. 9 is a diagram illustrating an exemplary setting screen of the reference pattern;

FIG. 10 is a diagram illustrating an exemplary setting screen of the reference pattern;

FIG. 11 is a flowchart illustrating operation examples of processing of the image inspection system according to the present embodiment;

FIG. 12 is a diagram illustrating exemplary read images read by two reading sections; and

FIG. 13 is a diagram illustrating an example in which reference patterns are applied to the read images in FIG. 12.

### DETAILED DESCRIPTION OF EMBODIMENTS

Hereinafter, one or more embodiments of the present invention will be described with reference to the drawings. However, the scope of the invention is not limited to the disclosed embodiments.

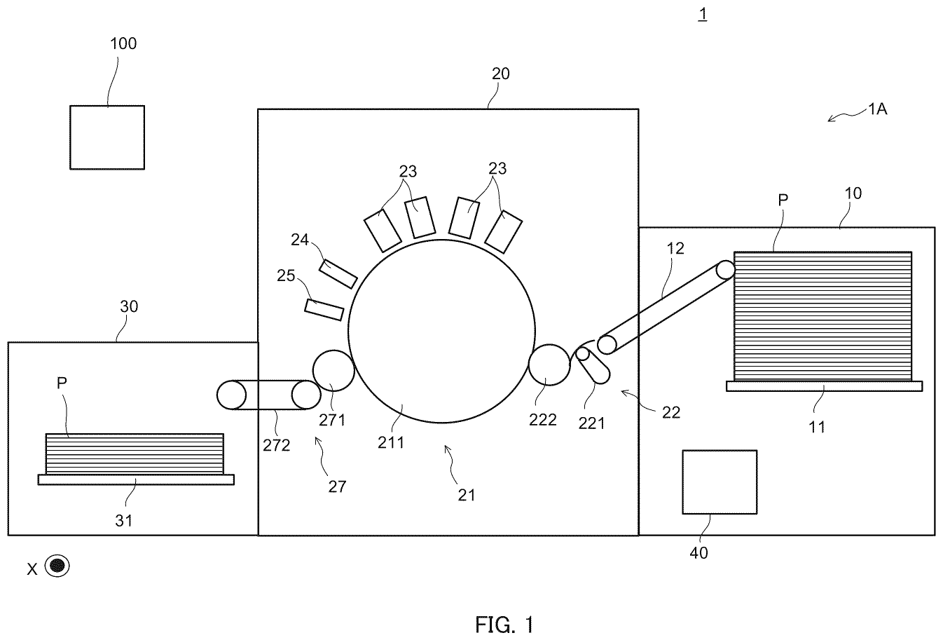

Hereinafter, an embodiment of the present invention will be described in detail with reference to the accompanying drawings. FIG. 1 is a diagram schematically illustrating an overall configuration of image inspection system 1 according to an embodiment of the present invention.

Image inspection system 1 is a system capable of executing inspection of an image formed on recording medium P. Specifically, image inspection system 1 executes inspection of an image by reading the image formed on recording medium P and executing comparison inspection between an inspection image generated based on the read image and a reference image. Image inspection system 1 includes image forming apparatus 1A and inspection apparatus 100. Image inspection system 1 corresponds to the “image inspection apparatus” in the present invention. Inspection apparatus 100 corresponds to an “inspection section” in the present invention.

Image forming apparatus 1A is an inkjet-type image forming apparatus that records an image for recording medium P. Image forming apparatus 1A includes sheet feed section 10, image forming section 20, sheet discharge section 30, and control section 40.

Under the control of control section 40, image forming apparatus 1A conveys recording medium P stored in sheet feed section 10 to image forming section 20, records an image by ejecting ink onto recording medium P at image forming section 20, and conveys recording medium P, on which the image has been recorded, to sheet discharge section 30.

Specifically, image forming apparatus 1A outputs four colors of yellow (Y), magenta (M), cyan (C), and black (K), each with a predetermined number of gradations, on recording medium P in a superposed manner to record a color image on recording medium P.

As recording medium P, in addition to sheet such as a plain sheet or a coated sheet, various media can be used on which ink having landed on the surface can be fixed, such as fabric or sheet-like resin.

Sheet feed section 10 includes sheet feed tray 11 that stores recording medium P, and medium supply section 12 that conveys and supplies recording medium P from sheet feed tray 11 to image forming section 20. Sheet supply section 12 includes a ring-shaped belt whose inner side is supported by two rollers, and rotates the rollers in a state of recording medium P being placed on the belt to convey recording medium P from sheet feed tray 11 to image forming section 20.

Image forming section 20 includes conveyance section 21, transfer unit 22, head unit 23, emission section 24, reading section 25, delivery section 27, and the like.

Conveyance section 21 holds recording medium P placed on a conveyance surface of conveyance drum 211 having a cylindrical shape, and conveys recording medium P on conveyance drum 211 in a conveyance direction along the conveyance surface as conveyance drum 211 rotates and circulates around a rotation axis (cylindrical axis) extending in the X direction perpendicular to the drawing in FIG. 1.

Conveyance drum 211 includes a claw section (not illustrated) and a suction section (not illustrated) which serve as holding recording medium P on the conveyance surface. Recording medium P is held on the conveyance surface such that an end part of recording medium P is pressed by the claw section and recording medium P is sucked to the conveyance surface by the suction section.

Transfer unit 22 is provided in a position between medium supply section 12 of sheet feed section 10 and conveyance section 21, and holds one end of recording medium P conveyed from medium supply section 12 with swing arm section 221 to pick recording medium P up, and hands over recording medium P to conveyance section 21 via transit drum 222.

Head unit 23 ejects ink from a nozzle opening section provided in an ink ejection surface, which faces the conveyance surface of conveyance drum 211, onto recording medium P at appropriate timings according to the rotation of conveyance drum 211, on which recording medium P is held, to record an image.

Head unit 23 is disposed such that the ink ejection surface and the conveyance surface are separated from each other by a predetermined distance. In image forming apparatus 1A in the present embodiment, four head units 23 which correspond to inks of the four colors Y, M, C, and K, respectively, are arranged at predetermined intervals in order of the colors of Y, M, C, and K from the upstream side in the conveyance direction of recording medium P. That is, head units 23 are configured to be capable of ejecting a plurality of different types of inks.

Head units 23 are used with the positions being fixed during image recording, and sequentially eject inks onto different positions in the conveyance direction at predetermined intervals (conveyance direction intervals) according to the conveyance of recording medium P to record an image in a single pass.

Emission section 24 is disposed across the width of conveyance section 21 in the X direction, and cures and fixes inks ejected onto recording medium P by emitting electromagnetic waves (for example, ultraviolet rays) to recording medium P placed on conveyance section 21. Emission section 24 is disposed to face the conveyance surface on the downstream side of the disposition positions of head units 23 in the conveyance direction.

Reading section 25 is, for example, a reading apparatus, such as a scanner, which is capable of reading an image formed on recording medium P that is conveyed on conveyance section 21. Reading section 25 is disposed to face the conveyance surface on the downstream side of the disposition position of emission section 24 in the conveyance direction.

Delivery section 27 includes belt loop 272, which includes a ring-shaped belt whose inner side is supported by two rollers, and transfer drum 271, which has a cylindrical shape and transfers recording medium P from conveyance section 21 to belt loop 272, and conveys recording medium P, which has been transferred from conveyance section 21 onto belt loop 272 by transfer drum 271, with belt loop 272 to send recording medium P to sheet discharge section 30.

Sheet discharge section 30 includes sheet discharge tray 31 which has a plate shape and on which recording medium P sent from image forming section 20 by delivery section 27 is placed.

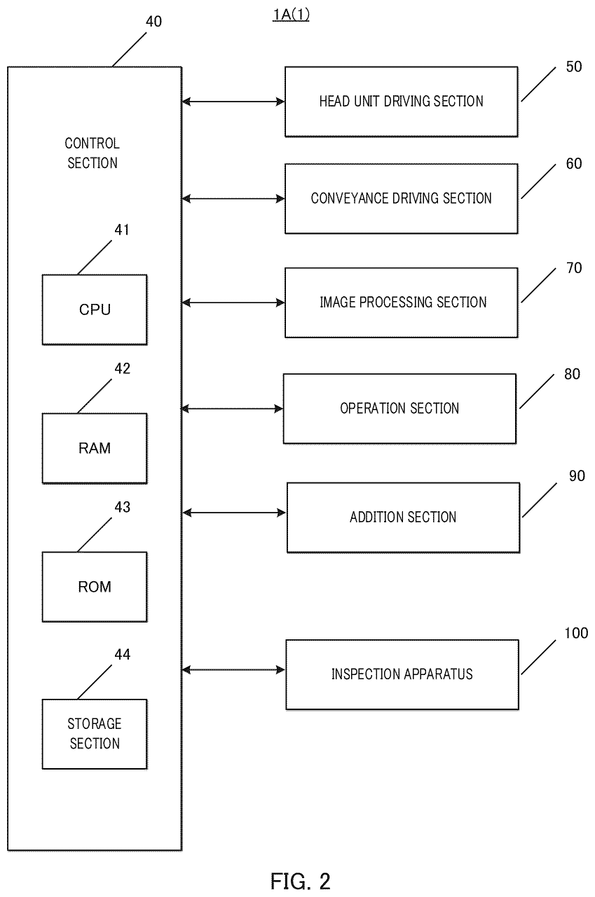

FIG. 2 is a block diagram illustrating a main functional configuration of image forming apparatus 1A. Image forming apparatus 1A includes control section 40, head unit driving section 50, conveyance driving section 60, image processing section 70, operation section 80, and addition section 90.

Control section 40 includes central processing unit (CPU) 41, random access memory (RAM) 42, read only memory (ROM) 43, and storage section 44, and comprehensively controls the entire operation of image forming apparatus 1A.

CPU 41 reads various control programs and setting data stored in ROM 43, stores the read programs and setting data in RAM 42, and executes the programs to carry out various types of calculation processing.

RAM 42 provides a working memory space for CPU 41 and stores temporary data. RAM 42 may include a non-volatile memory.

ROM 43 stores the various control programs to be executed by CPU 41, the setting data, and the like. Note that, a rewritable non-volatile memory such as an electrically erasable programmable read only memory (EEPROM) or a flash memory may be used instead of ROM 43.

Storage section 44 stores a print job inputted from an external apparatus (not illustrated) via operation section 80, image data of an image to be recorded by the print job, and the like. As storage section 44, for example, a hard disk drive (HDD) is used, and a dynamic random access memory (DRAM) or the like may also be used in combination.

Head unit driving section 50 supplies, based on the control of control section 40, driving signals corresponding to image data to recording elements of head units 23 at appropriate timings, thereby causing the nozzles of head units 23 to eject inks in an amount corresponding to the pixel value of image data.

Conveyance driving section 60 supplies a driving signal to a conveyance drum motor provided in conveyance drum 211 based on a control signal supplied from control section 40 to rotate conveyance drum 211 at predetermined speed and timing. In addition, conveyance driving section 60 supplies driving signals to motors for operating medium supply section 12, transfer unit 22, and delivery section 27 based on a control signal supplied from control section 40 to cause recording medium P to be supplied to and discharged from conveyance section 21.

Image processing section 70 performs predetermined image processing on image data stored in storage section 44 and causes storage section 44 to store the obtained image data. This image processing includes correction processing for correcting image data by applying a correction table (not illustrated) or the like to the image data, as well as color conversion processing, tone correction processing, pseudo halftone processing, and the like.

Operation section 80 is an input/output interface of image forming apparatus 1A, is connected to an input/output interface of an external apparatus (for example, inspection apparatus 100), and mediates data transmission and reception between control section 40 and the external apparatus. Operation section 80 is constituted by, for example, any of various serial interfaces and various parallel interfaces, or a combination thereof.

Addition section 90 executes processing of adding a reference pattern for alignment to image data during image inspection by inspection apparatus 100. The reference pattern is, for example, a pattern based on a trim mark which is a marker for a cutting position of recording medium P.

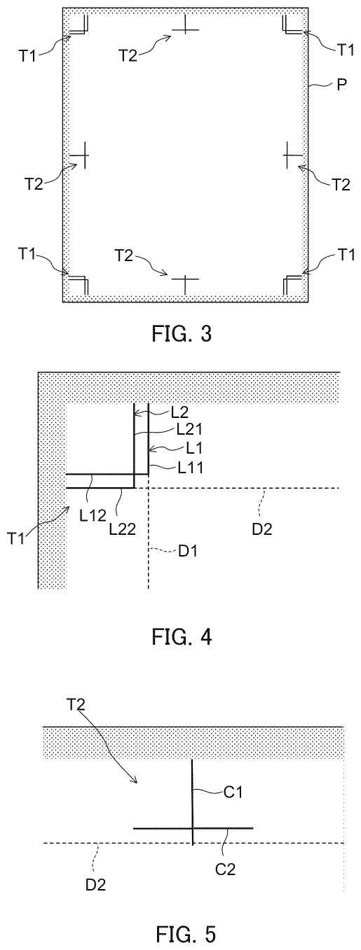

As illustrated in FIG. 3, the trim marks include corner marks T1 disposed in positions corresponding to the four corners of recording medium P and center marks T2 each of which is disposed in a center position between two corner marks T1.

As illustrated in FIG. 4, corner mark T1 is constituted by two L-shaped lines L1 and L2. L-shaped lines L1 and L2 are disposed so as to intersect with each other. Portion L11 of L-shaped line L1, which is parallel to the vertical direction (a first direction), is disposed so as to be located more on the inner side of recording medium P than portion L21 of L-shaped line L2, which is parallel to the vertical direction. Portion L22 of L-shaped line 2, which is parallel to the lateral direction (a second direction orthogonal to the first direction), is disposed so as to be located more on the inner side of recording medium P than portion L12 of L-shaped line L1, which is parallel to the lateral direction.

Portion L11 of L-shaped line L1 is a portion that is parallel to cutting line D1 of recording medium P in the first direction and corresponds to a cutting position of recording medium P in the first direction. Portion L22 of L-shaped line L2 is a portion that is parallel to cutting line D2 of recording medium P in the second direction and corresponds to a cutting position of recording medium P in the second direction. Portion L11 and portion L22 correspond to a “parallel portion” in the present invention.

As illustrated in FIG. 5, center mark T2 is constituted by cross lines. The cross lines are constituted by center portion C1 and orthogonal portion C2. In addition, center portion C1 is a portion corresponding to the center position between two corner marks T1 which are arranged in the first direction or the second direction.

Orthogonal portion C2 is a portion which is orthogonal to center portion C1 and is disposed parallel to a cutting line of recording medium P. In the case of center mark T2 corresponding to the center position between two corner marks T1 arranged in the first direction, orthogonal portion C2 is disposed parallel to cutting line D1 in the first direction. In the case of center mark T2 corresponding to the center position between two corner marks T1 arranged in the second direction, orthogonal portion C2 is disposed parallel to cutting line D2 in the second direction. FIG. 5 exemplifies center mark T2 in which orthogonal portion C2 is parallel to cutting line D2 in the second direction. Orthogonal portion C2 corresponds to the “parallel portion” in the present invention.

In addition, during image inspection, addition section 90 generates a reference pattern in a shape identifiable by inspection apparatus 100 based on the trim marks described above. Details of the generation of the reference pattern by addition section 90 will be described later.

Inspection apparatus 100 is an apparatus that includes a CPU, a RAM, a ROM, and a storage section, and executes comparison inspection between a read image read by reading section 25 and a reference image. Inspection apparatus 100 in the present embodiment is, for example, an apparatus, such as a personal computer, which is capable of communicating with image forming apparatus 1A via a network. Note that, inspection apparatus 100 is not limited thereto, and may be provided within image forming apparatus 1A, such as control section 40. Inspection apparatus 100 corresponds to the “inspection section” in the present invention.

The reference image is an image serving as a reference for image inspection, and is an image based on an image formed on recording medium P by image forming apparatus 1A before the image inspection. The reference image may be an image read by reading section 25, or may be an image based on image data that has been subjected to raster image processor (RIP) processing.

The inspection image is an image to be inspected. The inspection image is an image based on a read image generated by reading section 25 reading an image formed on recording medium P by image forming apparatus 1A.

Inspection apparatus 100 is capable of executing processing of converting the resolution of a read image. For example, inspection apparatus 100 reduces the resolution of a read image for high-speed processing of image inspection. In the present embodiment, it is assumed that the reference image and the inspection image are images obtained by reducing the resolutions of images read by reading section 25. Inspection apparatus 100 corresponds to a “resolution conversion section” in the present invention.

First, before image inspection, inspection apparatus 100 acquires information on a read image corresponding to a reference image and reduces the resolution of the image based on the information to generate the reference image.

In addition, inspection apparatus 100 generates, from a reference image as a target, an alignment model with which a satisfactory accuracy of alignment can be obtained. As algorithms for alignment, for example, a shape model and an NCC model are known. The shape model refers to an image for which feature points are extracted from image edges and alignment of the feature points is executed. The NCC model refers to an image for which alignment by image matching (alignment by normalized cross-correlation of a target area) is executed.

Inspection apparatus 100 then associates the generated alignment model with the reference image and registers the generated alignment associated with the reference image in a storage section (not illustrated) or the like.

Next, inspection apparatus 100 acquires information on a read image based on an image formed on recording medium P by image forming section 20, and reduces the resolution of the image based on the information to generate an inspection image.

In addition, inspection apparatus 100 searches for an alignment position(s) based on the alignment model associated with the reference image corresponding to the inspection image as a target. Inspection apparatus 100 aligns the inspection image or the reference image as the target based on information on alignment.

Then, inspection apparatus 100 performs comparison inspection between the inspection image and the reference image, and records an inspection result in an inspection report.

Incidentally, when the resolution of an image is reduced, the resolution of trim marks (reference pattern) added to image data for the sake of alignment is also reduced, and thus, the trim marks may not be identifiable when inspection apparatus 100 performs alignment in image inspection. For example, since an image is also reduced by reducing the resolution of the image, a trim mark smaller than an image to be inspected is likely to disappear or blur due to the reduction of the image.

For example, it is assumed that an image to be inspected (an image formed on a non-cutting portion of recording medium P) is an image that is likely to disappear due to the reduction of the image (for example, an image only with ruled lines). In this case, when a trim mark disappears or blurs, the image to be inspected may also disappear in the same manner as the trim mark, and thus, everything that serves as a reference for comparison in comparison inspection may disappear. As a result, alignment itself may become impossible.

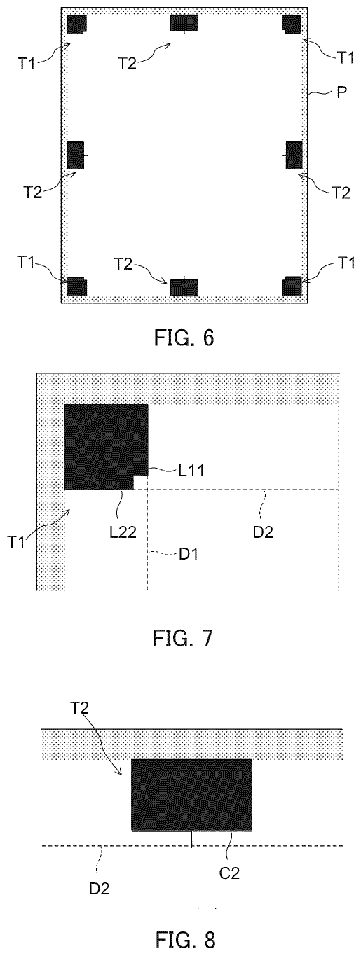

In this respect, in the present embodiment, addition section 90 generates a reference pattern in a shape identifiable by inspection apparatus 100 during image inspection as described above. Specifically, as illustrated in FIG. 6, addition section 90 generates a reference pattern such that a parallel portion of a trim mark, which is parallel to a cutting line of recording medium P, extends to the side opposite to a non-cutting portion of recording medium P.

The non-cutting portion of recording medium P is a portion of recording medium P, on which an image to be inspected in image inspection is formed, and is a portion surrounded by cutting lines D1 and D2.

For example, as illustrated in FIG. 7, addition section 90 extends portions L11 and L12 in corner mark T1 in a reference pattern. For portion L11, addition section 90 extends portion L11 such that portion L11 becomes thick on the left side in FIG. 7 with respect to cutting line D1 along the first direction. In addition, for portion L22, addition section 90 extends portion L22 such that L22 becomes thick on the upper side in FIG. 7 with respect to cutting line D2 along the second direction.

In addition, as illustrated in FIG. 8, addition section 90 extends orthogonal portion C2 such that orthogonal portion C2 becomes thick on the upper side in FIG. 8 with respect to cutting line D2 in center mark T2 in a reference pattern.

The range in which a reference pattern is extended is within a printable area for image forming section 20. For this reason, addition section 90 may extend a reference pattern to the boundary between the printable area and the non-printing area (the dot portion in FIG. 8 and the like). In addition, addition section 90 may not extend a reference pattern to the boundary between the printable area and the non-printable area, and may change the extension range of a reference pattern according to the resolution of an inspection image.

For example, in a case where comparison inspection is executed by configuring the resolution of an inspection image in the first direction to one-N-th (where N is a positive real number of 1 or more) the resolution of a read image (setting other than during image inspection), addition section 90 may extend the number of pixels in a parallel portion of a reference pattern in the first direction to N or more. In addition, in a case where comparison inspection is executed by configuring the resolution of an inspection image in the second direction to one-M-th (where M is a positive real number of 1 or more) the resolution of a read image, addition section 90 may extend the number of pixels in a parallel portion of a reference pattern in the second direction to M or more.

For example, when the resolution during image inspection is set to one-tenth the resolution of a read image, a portion in which the number of pixels in a reference pattern is less than 10 pixels disappears or blurs due to the reduction in resolution. In the present embodiment, however, it is ensured that a portion in which the number of pixels in a reference pattern is less than 10 pixels is extended such that the number of pixels in the portion is 10 pixels or more, and thus, the portion does not disappear even when the resolution is reduced.

In this way, it is possible to generate a reference pattern in a shape identifiable by inspection apparatus 100 regardless of the resolution of an inspection image.

In addition, image forming section 20 may form an image corresponding to a reference pattern with one color of YMCK (a plurality of colors).

When a reference pattern is generated with a plurality of colors, alignment between an inspection image and a reference image may be hindered when a color shift occurs in each color. Nonetheless, when a reference pattern is formed with one color of the plurality of colors, it is possible to prevent a color shift from occurring and to improve the accuracy of alignment between an inspection image and a reference image.

In addition, the reference pattern described above may be settable by the user via operation section 80. In other words, when the user selects a reference pattern via operation section 80, addition section 90 may add the reference pattern to image data.

The setting of a reference pattern may be, for example, setting of whether the reference pattern is added to image data.

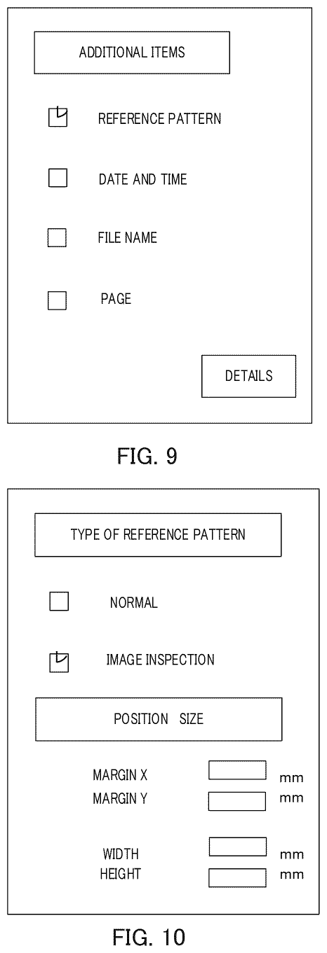

For example, when the check box of reference pattern is checked by the user on the setting screen illustrated in FIG. 9, a reference pattern is added to image data. Note that, the setting screen illustrated in FIG. 9 indicates, in addition to the reference pattern, additional items such as date and time, file name, and page.

In addition, operation section 80 may allow the type of the reference pattern, the position and size of the reference pattern, and the like to be set.

The type of the reference pattern may encompass a normal reference pattern and a reference pattern for image inspection. The normal reference pattern may be a reference pattern used other than during image inspection, for example, normal trim marks for cutting (see FIG. 3). The reference pattern for image inspection is a reference pattern used during image inspection, and may be a pattern (see FIG. 6) which is larger than the normal reference pattern. For example, when the user checks the check box of image inspection on the setting screen illustrated in FIG. 10, the type of the reference pattern is set to the reference pattern for image inspection.

The position and size of the reference pattern may include a margin(s) from an edge part(s) of recording medium P and the width and height of the reference pattern. The position and size of the reference pattern are set based on numerical values inputted by the user via operation section 80. For example, the margin(s), the width, and the height are set by the user inputting numerical values on the setting screen illustrated in FIG. 10. In this way, the position and size of the reference pattern can be adjusted according to the user's preference.

Note that, the display of the setting screen illustrated in FIG. 10 may be transitionable from the display of the setting screen illustrated in FIG. 9, for example. For example, when the user performs an input of “details” on the setting screen illustrated in FIG. 9, the display may transition to the setting screen illustrated in FIG. 10.

In addition, for the position and size of the reference pattern, values corresponding to a shape identifiable by inspection apparatus 100 may be set as default values for operation section 80 during image inspection regardless of the resolution of an inspection image. That is, during image inspection, there may be a state in which default values have been inputted in advance in the fields for the margin(s), the width, and the height in FIG. 10. This makes it possible to save the user the trouble of inputting the position and size of the reference pattern.

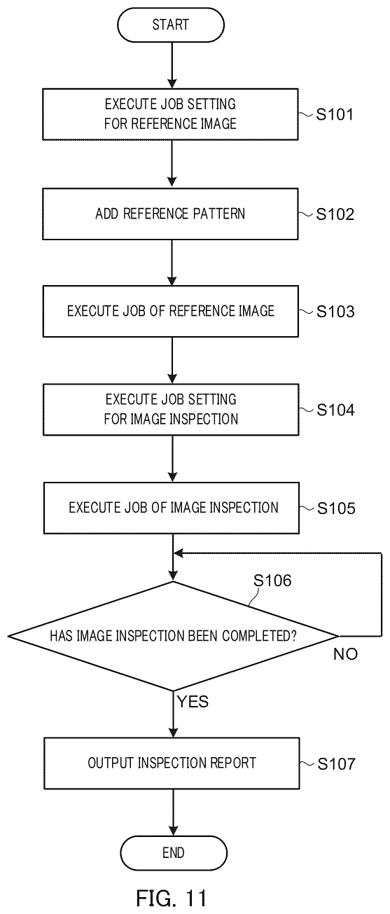

Next, a flow of control of image inspection system 1 according to the present embodiment will be described. FIG. 11 is a flowchart illustrating operation examples of processing of image inspection system 1 according to the present embodiment. Note that, the processing in FIG. 11 is appropriately executed, for example, when the setting of a print job of a reference image in image inspection is executed.

As illustrated in FIG. 11, inspection apparatus 100 executes job setting for a reference image (step S101). The job setting for the reference image may be executed, for example, based on an input by the user via operation section 80.

When the job setting for the reference image is executed, addition section 90 adds a reference pattern to image data (step S102). Note that, the addition of the reference pattern may not be performed in the job setting for the reference image, and may be performed, for example, before the processing in step S101. Then, image inspection system 1 executes the job of the reference image (step S103).

Specifically, control section 40 forms an image corresponding to the reference image on recording medium P, and reading section 25 acquires a read image. Then, inspection apparatus 100 reduces the resolution of the read image and registers the read image as the reference image. Note that, in a case where the reference image is an image based on image data that has been subjected to RIP (Raster Image Processor) processing, the processing in step S103 may not be executed.

After step S103, inspection apparatus 100 executes job setting for image inspection (step S104). The job setting for image inspection may be executed, for example, based on an input by the user via operation section 80. The job setting for image inspection may be, for example, setting of an inspection exclusion area and setting of an inspection level for each area. In addition, the job setting for image inspection may include setting of processing contents (for example, continuation, stop, recovery and restart, and the like) in a case where an inspection failure is detected (for example, detection of a waste sheet or the like) during the job of the image inspection.

After step S104, image inspection system 1 executes the job of the image inspection (step S105). Specifically, control section 40 forms an image to be inspected on recording medium P, and reading section 25 acquires a read image. Then, inspection apparatus 100 performs comparison inspection between an inspection image obtained by reducing the resolution of the read image and the reference image.

After step S105, image inspection system 1 determines whether the job of the image inspection has been completed (step S106). In a case where the job of the image inspection has not been completed as a result of the determination (NO in step S106), the processing in step S106 is repeated.

In a case where the job of the image inspection has been completed (YES in step S106), on the other hand, inspection apparatus 100 outputs an inspection report (step S107). Thereafter, the present control ends.

According to the present embodiment configured as described above, addition section 90 generates, during image inspection, a reference pattern in a shape identifiable by inspection apparatus 100 regardless of the resolution of an inspection image.

Thus, even when the resolution of an inspection image is reduced during image inspection, inspection apparatus 100 can surely identify a reference pattern. As a result, it is possible to improve the accuracy of alignment between an inspection image and a reference image during image inspection.

In addition, image forming section 20 forms an image corresponding to a reference pattern with one color of a plurality of colors. In a case where a reference pattern is formed with a plurality of colors, a color shift may occur and alignment may be hindered during image inspection, but in the present embodiment, there is no risk of a color shift, and thus, it is possible to improve the accuracy of alignment between an inspection image and a reference image.

In addition, the reference pattern is a pattern based on a trim mark including a parallel portion parallel to a cutting line of recording medium P, and addition section 90 generates a reference pattern such that the parallel portion extends to the side opposite to a non-cutting portion of recording medium P.

Since the trim mark is formed in a linear shape, a line portion thereof is likely to disappear or blur in a line portion thereof is likely to occur when the resolution is reduced. In the present embodiment, on the other hand, the parallel portion of the trim mark is extended by addition section 90, and thus, the parallel portion of the trim mark can be prevented from disappearing or blurring even when the resolution is reduced. As a result, it is possible to improve the accuracy of alignment between an inspection image and a reference image.

In addition, since the range in which a reference pattern is extended is within a printable area for image forming section 20, a reference pattern can be surely formed on recording medium P. As a result, it is possible to surely perform alignment between an inspection image and a reference image during image inspection.

In addition, in a case where comparison inspection is executed by configuring the resolution of an inspection image in the first direction to one-N-th (where N is a positive real number of 1 or more) the resolution of a read image, addition section 90 extends the number of pixels in a parallel portion in the first direction to N or more. Further, in a case where comparison inspection is executed by configuring the resolution of an inspection image in the second direction to one-M-th (where M is a positive real number of 1 or more) of the resolution of a read image, addition section 90 extends the number of pixels in a parallel portion in the second direction to M or more.

Thus, even when the resolution is lower than the resolution of a read image during image inspection, it is possible to prevent a reference pattern from disappearing or blurring, and thus, it is possible to surely perform alignment between an inspection image and a reference image.

Further, a plurality of the trim marks includes two center marks formed so as to hold a non-cutting portion of recording medium P therebetween in the center of recording medium P in the width direction of recording medium P, and addition section 90 extends a parallel portion of each of four corner marks and the parallel portion of each of the two center marks.

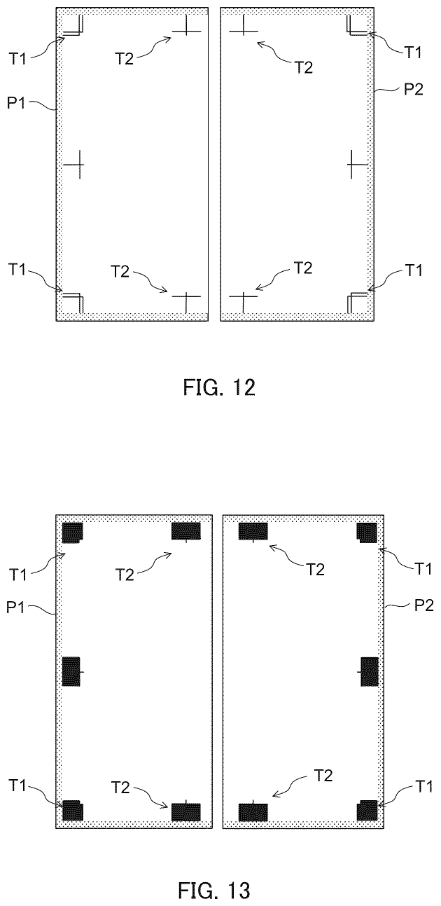

Here, for example, in image forming apparatus 1A capable of forming an image on recording material P having a wide width, such as a sheet of A3 size, a plurality of reading sections 25 may be provided side by side in the width direction of recording medium P (the direction corresponding to the second direction). In such a case, as illustrated in FIG. 12, read images read by reading sections 25 become images as if the images are obtained by dividing an image formed on recording medium P.

FIG. 12 illustrates exemplary read images when two reading sections 25 read one image on recording medium P. P1 is a read image read by one of two reading sections 25. P2 is a read image read by the other of two reading sections 25.

Read image P1 includes two center marks T2, which hold an image (non-cutting portion) formed on recording medium P therebetween in the first direction (longitudinal direction), and corner marks T1 each of which corresponds to one of the both end parts of recording medium P in the second direction (lateral direction). Read image P2 includes two center marks T2, which hold an image (non-cutting portion) formed on recording medium P therebetween in the first direction, and corner marks T1 each of which corresponds to the other of the both end parts of recording medium P in the second direction.

For example, in a case where two center marks which hold the non-cutting portion therebetween in the first direction are not formed, read images obtained by dividing an image formed on recording medium P in this manner include only corner marks each of which corresponds to one or the other of the both end parts of recording medium P in the second direction. That is, since a reference pattern exists only on one side or the other side of recording medium P in the second direction in each read image, alignment may be hindered.

In the present embodiment, on the other hand, two center marks T2 are formed so as to hold the non-cutting portion of recording medium P therebetween, and thus, the read images include two reference patterns located on the both sides of recording medium P in the second direction. As a result, even when an image is divided in each read image due to the extension of the trim marks of each read image (see FIG. 13), alignment between an inspection image and a reference image can be surely performed.

In addition, the center mark located in the center in the first direction may be extended or may not be extended.

Note that, in the embodiment described above, the resolution of a read image is reduced by inspection apparatus 100 (inspection section), but the present invention is not limited thereto, and the resolution of a read image may be reduced by image forming apparatus 1A. For example, image forming apparatus 1A may include a resolution conversion section, and the resolution conversion section may reduce the resolution of a read image read by reading section 25 in setting other than during image inspection and output the read image to inspection apparatus 100. In addition, image forming apparatus 1A may output, as an inspection image, a read image read by reading section 25 at a lower resolution than that in setting other than during image inspection to inspection apparatus 100. In this case, reading section 25 corresponds to the “resolution conversion section” in the present invention.

In addition, in the embodiment described above, inspection apparatus 100 executes, during image inspection, comparison inspection by using an inspection image whose resolution is lower than that in setting other than during the image inspection, but the present invention is not limited thereto. For example, during image inspection, inspection apparatus 100 may execute comparison inspection by using the same inspection image as that in setting other than during the image inspection. In this case, the reference pattern may be, for example, a pattern illustrated in FIG. 6 or the like.

In addition, in the embodiment described above, image forming section 20 forms an image corresponding to a reference pattern with one color of a plurality of colors, but the present invention is not limited thereto, and image forming section 20 may form an image corresponding to a reference pattern with two or more colors of the plurality of colors.

In addition, in the embodiment described above, a reference pattern is set based on an input by the user via operation section 80, but the present invention is not limited thereto, and a reference pattern may be automatically set, not via operation section 80.

In addition, in the embodiment described above, the reference pattern is a pattern based on a trim mark, but the present invention is not limited thereto, and the reference pattern may not be a pattern based on a trim mark, but may be a pattern based on a shape along a cutting line, a shape having a portion parallel to a cutting line, or the like.

In addition, in the embodiment described above, an image forming apparatus of an inkjet system is exemplified, but the present invention is not limited thereto, and the image forming apparatus may be an image forming apparatus other than that of an inkjet system (for example, an image forming apparatus of an electrophotographic system).

In addition, any of the embodiment described above is only illustration of an exemplary embodiment for implementing the present invention, and the technical scope of the present invention shall not be construed limitedly thereby. That is, the present invention can be implemented in various forms without departing from the gist or the main features thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image inspection apparatus, comprising:
a hardware processor that adds a reference pattern for alignment to image data;
an image former that forms, on a recording medium, an image based on the image data to which the reference pattern has been added;
a reader that reads the image formed on the recording medium to generate a read image, wherein
the hardware processor generates, during image inspection, the reference pattern in a shape identifiable by the hardware processor regardless of a resolution of an inspection image, and executes comparison inspection between the inspection image based on the read image and a reference image.

2. The image inspection apparatus according to claim 1, wherein:
the hardware processor is capable of executing processing of converting a resolution of data of an image, and
the hardware processor executes, during the image inspection, the comparison inspection by using the inspection image having the resolution lower than a resolution of the read image.

3. The image inspection apparatus according to claim 1, wherein:
the image former is capable of forming the image on the recording medium by using a plurality of colors, and
the image former forms an image corresponding to the reference pattern with one color of the plurality of colors.

4. The image inspection apparatus according to claim 1, wherein:
the reference pattern is a pattern based on a trim mark, the trim mark being a marker for a cutting position of the recording medium and including a parallel portion parallel to a cutting line of the recording medium, and
the hardware processor generates the reference pattern such that the parallel portion extends to a side opposite to a non-cutting portion of the recording medium.

5. The image inspection apparatus according to claim 4, wherein
a range in which the reference pattern is extended is within a printable area for the image former.

6. The image inspection apparatus according to claim 4, wherein:
the hardware processor extends, in a case where the comparison inspection is executed by configuring the resolution of the inspection image in a first direction to be one-N-th the resolution of the read image, a number of pixels in the parallel portion in the first direction to N or more, N being a positive real number of 1 or more, and
the hardware processor extends, in a case where the comparison inspection is executed by configuring the resolution of the inspection image in a second direction orthogonal to the first direction to be one-M-th a resolution of the read image, a number of pixels in the parallel portion in the second direction to M or more, M being a positive real number of 1 or more.

7. The image inspection apparatus according to claim 4, wherein:
a plurality of the trim marks includes four corner marks and two center marks, the four corner marks being formed in positions corresponding to four corners of the recording medium, respectively, the two center marks being disposed so as to hold the non-cutting portion of the recording medium therebetween in a center of the recording medium in a width direction of the recording medium, and
the hardware processor extends a parallel portion of each of the four corner marks and the parallel portion of each of the two center marks.

8. The image inspection apparatus according to claim 1, further comprising an operator that is operable by a user, wherein
in a case where the user selects the reference pattern via the operator, the hardware processor adds the reference pattern to the image data.

9. The image inspection apparatus according to claim 1, wherein
the hardware processor configures the reference pattern used during the image inspection to be larger than the reference pattern used other than during the image inspection.

10. The image inspection apparatus according to claim 1, further comprising an operator that is operable by a user, wherein
a position and a size of the reference pattern are set based on numerical values inputted by the user via the operator.

11. The image inspection apparatus according to claim 10, wherein
for the position and the size of the reference pattern, values corresponding to a shape identifiable by the hardware processor are set as default values for the operator regardless of the resolution of the inspection image during the image inspection.

12. The image inspection apparatus according to claim 1, wherein
the reference image is generated when the reader reads the image formed on the recording medium.

13. The image inspection apparatus according to claim 1, wherein
the reference image is an image based on image data that has been subjected to RIP processing.

14. A non-transitory computer-readable recording medium storing an image inspection program to be executed by an image inspection apparatus, the image inspection program causing a computer to execute:
adding a reference pattern for alignment to image data;
forming, on a recording medium, an image based on the image data to which the reference pattern has been added;
reading the image formed on the recording medium to generate a read image; and
inspecting in which comparison inspection between an inspection image based on the read image and a reference image is executed, wherein
the adding includes generating the reference pattern in a shape identifiable by the image inspection apparatus regardless of a resolution of the inspection image during image inspection.

15. An image inspection method which is used by an image inspection apparatus, the image inspection method comprising:
adding a reference pattern for alignment to image data;
forming, on a recording medium, an image based on the image data to which the reference pattern has been added;
generating a read image by reading the image formed on the recording medium; and
executing comparison inspection between an inspection image based on the read image and a reference image, wherein
the adding includes generating the reference pattern in a shape identifiable by the image inspection apparatus regardless of a resolution of the inspection image during image inspection.
